(19) United States
(12) Patent Application Publication
(10) Pub. No.: US 2024/0241468 A1
(43) Pub. Date: Jul. 18, 2024

(54) IMAGE FORMING APPARATUS

(71) Applicant: CANON KABUSHIKI KAISHA, Tokyo (JP)

(72) Inventor: HIROKI KAWAI, Chiba (JP)

(21) Appl. No.: 18/412,339

(22) Filed: Jan. 12, 2024

(30) Foreign Application Priority Data
Jan. 18, 2023 (JP) 2023-005541
Nov. 7, 2023 (JP) 2023-190436

(51) Int. Cl. G03G 15/20; G03G 15/00

(52) U.S. Cl. CPC G03G 15/2064; G03G 15/2046; G03G 15/655

(57) ABSTRACT

An image forming apparatus includes an image forming unit, a heating rotary member, and a pressure rotary member that forms a nip portion with the heating rotary member to perform printing on a first recording material with a first width, a second recording material with a second width and has no image to be formed thereon, and a third recording material with the second width and has an image to be formed thereon. A time period from when the first recording material reaches the nip portion to when the second recording material that has no image to be formed thereon and follows the first recording material reaches the nip portion is shorter than a time period from when the first recording material reaches the nip portion to when the third recording material having an image to be formed thereon that follows the first recording material reaches the nip portion.

### BACKGROUND

### Field

The present disclosure relates to an image forming apparatus that forms an image on a recording material.

### Description of the Related Art

A multi-function peripheral (MFP) is known as an image forming apparatus that continuously performs printing on a plurality of recording materials. An MFP includes a fixing device including a photosensitive drum, a transfer member, and a heating member. The MFP forms an image on each recording material in the following manner. First, a toner image formed on a surface of the photosensitive drum is transferred onto the recording material. The fixing device performs a heating process and a pressurization process on the recording material carrying the toner image. As a result, the toner image is fixed onto the recording material.

The MFP is configured to continuously perform printing on a plurality of recording materials with different sizes.

In a case where printing is performed on a recording material with a width greater than that of a preceding recording material after printing is performed on the preceding recording material, a temperature control process is executed to improve the image quality. Specifically, a heat equalization process is carried out. When a toner image is fixed onto a recording material with a smaller width, the temperature of a non-sheet-passing area is high and the temperature of a sheet-passing area is low, so that temperature non-uniformity occurs. If a toner image is fixed onto a recording material with a larger width in this state, uneven glossiness of the image may occur. Accordingly, a process is executed so that the heat in the sheet-passing area where the recording material with a larger width passes becomes uniform.

Japanese Patent Application Laid-Open No. 2013-231927 discusses an example of the heat equalization process. In the case of fixing a toner image onto a recording material with a larger width after fixing a toner image onto a recording material with a smaller width, the area corresponding to the sheet-passing area where the recording material with a larger width passes is heated to thereby obtain the advantageous effect of making the heat in a sheet width direction uniform.

On the other hand, as discussed in Japanese Patent Application Laid-Open No. 2018-15960, a divider sheet insertion job is conducted at a marketplace. Such a divider sheet is inserted every predetermined number of sheets or every predetermined number of copies, thereby enabling a user to easily determine the separation between printed materials.

In the case of continuously fixing a toner image onto sheets with different widths in the sheet width direction, it is known that the temperature control process for making the heat in the width direction uniform is carried out to prevent uneven glossiness in the width direction.

In the case of using a divider sheet, the width of the divider sheet is greater than the width of other sheets in the same job in many cases. This is because the divider sheet is often used for the user to easily determine the separation between printed materials. Since the divider sheet is simply used as the separation between printed materials, images are formed on the divider sheet only in a few cases, and thus the divider sheet is not required to have high image quality. However, in the related art, if printing is performed on a divider sheet, the temperature control process is carried out to address the temperature non-uniformity due to the difference in width between sheets, which leads to a deterioration in productivity.

### SUMMARY

The present disclosure is directed to improving productivity in a job using a divider sheet.

According to an aspect of the present disclosure, an image forming apparatus includes an image forming unit configured to form a toner image on a recording material, a heating rotary member configured to apply heat to the recording material carrying the toner image, and a pressure rotary member configured to contact with the heating rotary member to form a nip portion, wherein the pressure rotary member and the heating rotary member are configured to apply heat and pressure to the recording material carrying the toner image to fix the toner image onto the recording material, wherein the image forming apparatus is configured to perform printing on a recording material with a first width and a recording material with a second width, wherein the first width is a length of the recording material in a width direction perpendicular to a conveyance direction of the recording material, and the second width is greater than the first width, and wherein a period of time from when a first recording material with the first width reaches the nip portion to when a second recording material with the second width, that follows the first recording material with the first width and has no image to be formed thereon by the image forming unit, reaches the nip portion is shorter than a period of time from when the first recording material with the first width reaches the nip portion to when a third recording material with the second width that follows the first recording material with the first width and has an image to be formed thereon by the image forming unit reaches the nip portion.

Further features of the present disclosure will become apparent from the following description of exemplary embodiments with reference to the attached drawings.

### BRIEF DESCRIPTION OF THE DRAWINGS

FIG. 1 is a sectional view schematically illustrating a configuration of an image forming apparatus according to a first exemplary embodiment.

FIG. 2 is a block diagram schematically illustrating a configuration example of a controller according to the first exemplary embodiment.

FIG. 3 is a block diagram schematically illustrating a configuration example of each software module according to the first exemplary embodiment.

FIG. 4 illustrates an example of a heat equalization process according to the first exemplary embodiment.

FIG. 5 illustrates an example of a divider sheet.

FIG. 6 is a flowchart illustrating a procedure for print quality improvement processing execution control processing according to the first exemplary embodiment.

FIG. 7 is a graph illustrating a comparison between an elapsed time before a printing operation ends in the related art and the elapsed time in the first exemplary embodiment.

FIG. 8 is a flowchart illustrating a procedure for a modified example of the print quality improvement processing execution control processing.

### DESCRIPTION OF THE EMBODIMENTS

### Image Forming Apparatus

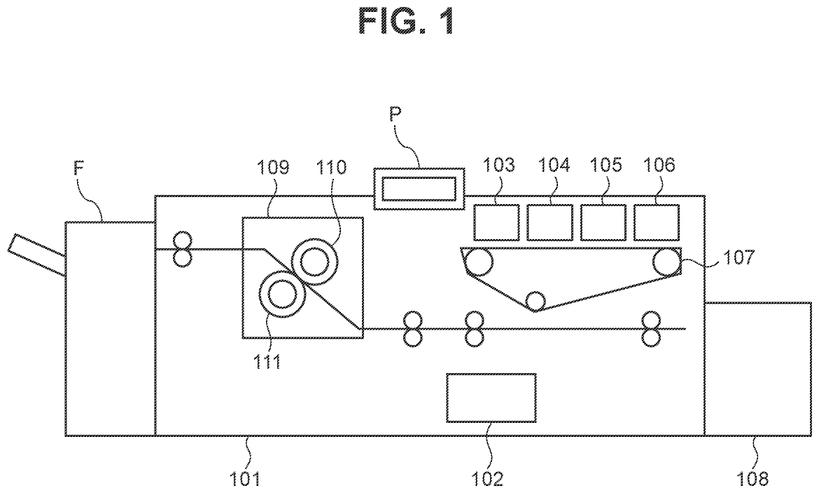

A first exemplary embodiment will be described in detail below with reference to the drawings. FIG. 1 is a sectional view schematically illustrating a configuration example of a multi-function peripheral (MFP) 101 as an image forming apparatus according to the first exemplary embodiment. In the configuration example illustrated in FIG. 1, the MFP 101 includes a controller 102, an operation unit P, developing devices 103 to 106, and an intermediate transfer belt 107, and accommodates recording materials.

The MFP 101 also includes a sheet feed cassette 108, a sheet discharge unit F, and a fixing device 109. The fixing device 109 includes a heating member (fixing roller) 110 and a pressure member (pressure roller) 111. In the present exemplary embodiment, the heating member 110 and the pressure member 111 are rollers, but instead may include a belt.

The fixing device 109 further includes a central thermistor 112 and end thermistors 113. The central thermistor 112 detects a temperature of a central portion of the fixing roller 110 in a width direction of a recording material. Each end thermistor 113 detects a temperature of an area of the fixing roller 110 on the outside of a recording material with a minimum width in the width direction of the recording material. In the present exemplary embodiment, the central thermistor 112 and the end thermistors 113 are configured to detect the temperature of the fixing roller 110 in a non-contact manner, but instead may be contact thermistors.

The MFP 101 receives an input from the operation unit P, or print data from an external apparatus (not illustrated), and performs printing on the recording material based on the print data. The MFP 101 is configured to continuously perform printing on a plurality of recording materials with different sizes in the width direction of each recording material. The controller 102 controls the overall operation of the MFP 101 in an integrated manner. For example, the controller 102 generates image data for printing based on the received print data. The developing devices 103 to 106 are developing devices for cyan (C), magenta (M), yellow (Y), and black (K), respectively. Upon obtaining the image data generated by the controller 102, the developing devices 103 to 106 develop an image corresponding to the image data on photosensitive drums (not illustrated) provided at the developing devices 103 to 106, respectively, and cause a toner image to adhere to the surfaces of developing portions (not illustrated). The developing devices 103 to 106 transfer the toner image adhering to the surfaces of the developing portions onto the surface of the intermediate transfer belt 107. The intermediate transfer belt 107 transfers the toner image onto a recording material fed from the sheet feed cassette 108. The recording material onto which the toner image is transferred is conveyed to the fixing device 109. For example, if recording materials with different widths are continuously conveyed, the recording materials are conveyed to the fixing device 109 in such a manner that central positions bisecting the width of each recording material are aligned. The heating member 110 and the pressure member 111 that are included in the fixing device 109 form a nip portion. The recording material carrying the toner image is conveyed to the nip portion. At the nip portion, the heating member 110 and the pressure member 111 apply heat and pressure to the recording material carrying the toner image. As a result, the toner image is fixed onto the recording material. The recording material onto which the toner image has been fixed is discharged onto the sheet discharge unit F.

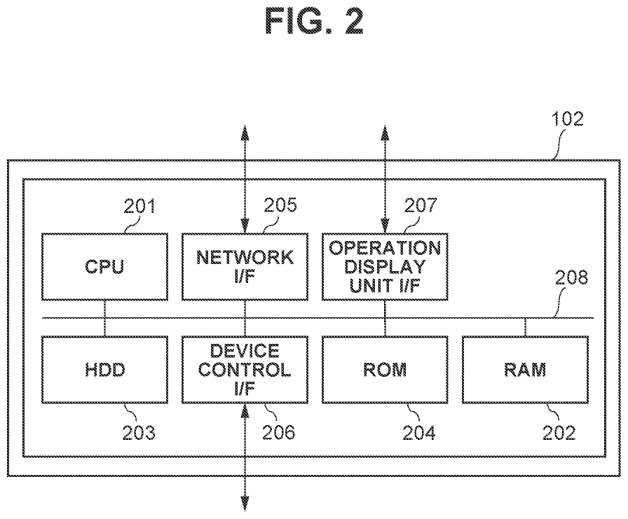

FIG. 2 is a block diagram schematically illustrating a configuration example of the controller 102 illustrated in FIG. 1. In the configuration example illustrated in FIG. 2, the controller 102 includes, as components, a central processing unit (CPU) 201, a random access memory (RAM) 202, a hard disk drive (HDD) 203, a read-only memory (ROM) 204, a network interface (I/F) 205, a device control I/F 206, and an operation unit I/F 207. These components are interconnected via a system bus 208. The CPU 201 executes programs stored in the HDD 203 or the ROM 204 to thereby perform processing on a software module 300 to be described below. The RAM 202 is used as a work area for the CPU 201. The RAM 202 is a temporary storage area for storing each piece of data. The HDD 203 is a large-capacity storage device and stores control programs and the like. The ROM 204 stores a boot processing program for a printing apparatus and the like. The operation unit I/F 207 communicates data with the operation unit P. The network I/F 205 communicates data with an external apparatus (not illustrated), and receives, for example, print data from the external apparatus. The device control I/F 206 controls driving of devices such as a motor and sensors (not illustrated) that are provided in the MFP 101.

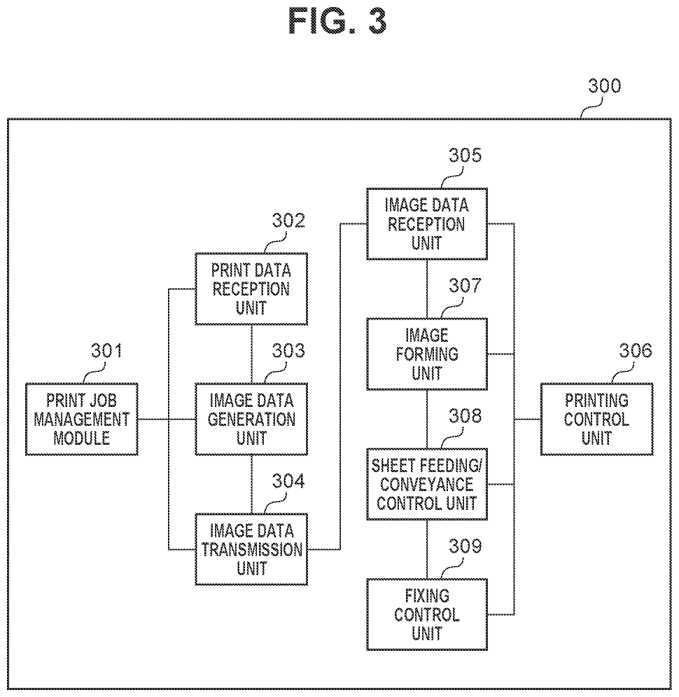

FIG. 3 is a block diagram schematically illustrating a configuration example of the software module 300 of the MFP 101 illustrated in FIG. 1.

In the configuration example illustrated in FIG. 3, the software module 300 includes a print job management module 301, a print data reception unit 302, an image data generation unit 303, an image data transmission unit 304, and an image data reception unit 305. The software module 300 also includes a printing control unit 306, an image forming unit 307, a sheet feeding/conveyance control unit 308, and a fixing control unit 309 (temperature control unit). Each processing of the software module 300 is performed such that the CPU 201 executes programs stored in the HDD 203 or the ROM 204.

The print job management module 301 manages print jobs for executing print data received from an external apparatus. The print data reception unit 302 receives print data from the network I/F 205 or the operation unit I/F 207, and temporarily stores the print data in the RAM 202 or the like. The image data generation unit 303 analyzes the received print data and performs raster image processor (RIP) processing on the print data to thereby generate image data. The image data is generated for each recording material or the like to be printed, and includes recording material size information, such as the width of each recording material to be printed, and information indicating a margin area excluding a print area on each recording material. The image data is temporarily stored in the RAM 202 or the like. The image data transmission unit 304 generates a control command for instructing execution of image data stored in the RAM 202 and the like, and transmits the control command and the image data to the image data reception unit 305. The image data reception unit 305 transmits the received control command to the printing control unit 306. The printing control unit 306 instructs the image forming unit 307, the sheet feeding/conveyance control unit 308, and the fixing control unit 309 to execute printing based on the received control command. Upon receiving image data from the printing control unit 306 as an instruction to execute printing, the image forming unit 307 executes exposure processing, development processing, transfer processing, separation processing, and cleaning processing based on the image data. The sheet feeding/conveyance control unit 308 controls a motor, a clutch, a solenoid, a recording material detection sensor, and the like (not illustrated), to thereby control feeding and conveyance of each recording material. The fixing control unit 309 controls the temperature of the fixing device 109, to thereby control fixing processing for fixing toner onto the recording material. The sheet feeding/conveyance control unit 308 controls the distance between sheets as the distance between one recording material and another recording material, and controls a period of time from when a recording material reaches the nip portion of the fixing device 109 to when another recording material that follows the recording material reaches the nip portion. Generally, in the case of continuously fixing an image onto recording materials with the same width, the sheet feeding/conveyance control unit 308 sets a period of time for conveying a recording material and another recording material following the recording material as a first period of time.

Print quality improvement processing (print engine adjustment processing) to be executed by the MFP 101 will be described. The print quality improvement processing is generally performed in a case where printing is performed on a second recording material having a width greater than that of a first recording material after printing is performed on the first recording material. In the present exemplary embodiment, the width of each recording material indicates a length between ends of the recording material in the width direction perpendicular to a conveyance direction in which each recording material is conveyed to the fixing device 109.

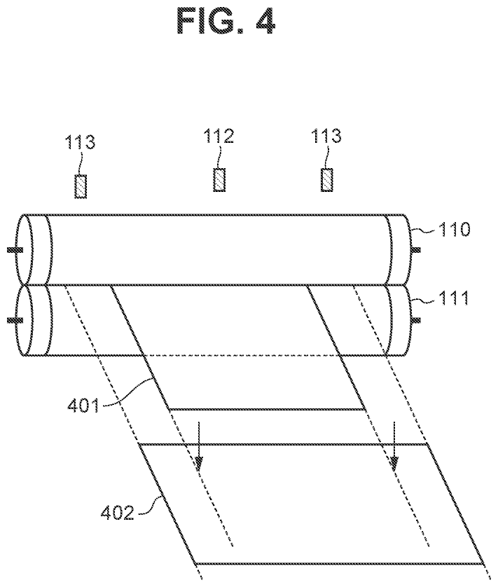

In the MFP 101, as illustrated in FIG. 4, if printing is performed on a recording material 402 having a width greater than that of a recording material 401 after printing is performed on the recording material 401, the print quality of the recording material 402 may deteriorate. For example, if the MFP 101 continuously performs printing on a large number of recording materials with the same width as that of the recording material 401, the heat in a non-sheet-passing area on the fixing roller 110 through which the recording material 401 does not pass is not absorbed by the recording material 401. Accordingly, the temperature of the non-sheet-passing area is higher than the temperature of a sheet-passing area through which the recording material 401 has passed. This causes a temperature difference between the sheet-passing area and the non-sheet-passing area of the recording material 401 on the fixing roller 110. If the recording material 402 having a width greater than that of the recording material 401 is conveyed to the nip portion in a state where the temperature difference has occurred, a difference in fixing strength occurs in printing on the recording material 402, so that uneven glossiness occurs on the image. Specifically, the glossiness in an area that is on the recording material 402 and is outside of the width of the recording material 401 is higher than that in an area that is inside of the width of the recording material 401, and this glossiness difference is visually observed as unevenness.

On the other hand, in the present exemplary embodiment, if printing is performed on the recording material 402 with a second width greater than the width of the recording material 401 after printing is performed on the recording material 401 with a first width, temperature control processing for making the surface temperature of the fixing roller 110 uniform is performed before printing on the recording material 402 is started. In the present exemplary embodiment, the temperature control processing for controlling the surface temperature of the fixing roller 110 is defined as print quality improvement processing. The print quality improvement processing is performed on the fixing device 109 so as to prevent deterioration in print quality.

A specific operation of the print quality improvement processing according to the present exemplary embodiment will be described. After the recording material 401 illustrated in FIG. 4 is conveyed to the fixing device 109, a printing operation is temporarily put into a standby state immediately before the recording material 402 having a width greater than that of the recording material 401 is conveyed, and the operation of conveying the recording material to the nip portion is suspended. The fixing control unit 309 performs temperature control processing for a predetermined period of time so as to obtain a uniform surface temperature distribution in the width direction of the fixing roller 110, and then the printing operation is resumed. The printing operation is suspended for a predetermined period of time. However, instead of performing the operation in this manner, for example, a method for calculating a temperature difference may be used. Specifically, the fixing control unit 309 calculates a difference between the temperature of the sheet-passing area of the recording material 401 and the temperature of the non-sheet-passing area of the recording material 401 by means of detecting the surface temperature of the fixing roller 110, and suspends the printing operation until the difference becomes less than or equal to a predetermined temperature. Thus, in the case of performing the print quality improvement processing, the difference between the temperature of the sheet-passing area of the first recording material 401 and the temperature of each of the sheet-passing area of the second recording material 402 and the non-sheet-passing area of the first recording material 401 decreases.

The print quality improvement processing according to the present exemplary embodiment is described with a focus on the recording material width direction. However, an operation similar to that described above may be performed even in a case where recording materials have different lengths in a length direction thereof. In addition to the above-described processing, surface polishing processing for repairing a damage to the surface of the fixing roller 110 due to an end surface of a recording material in the width direction, that is, a so-called sheet edge portion, calibration processing for adjustment of the photosensitive drum (not illustrated) and adjustment of colors, and the like may also be performed.

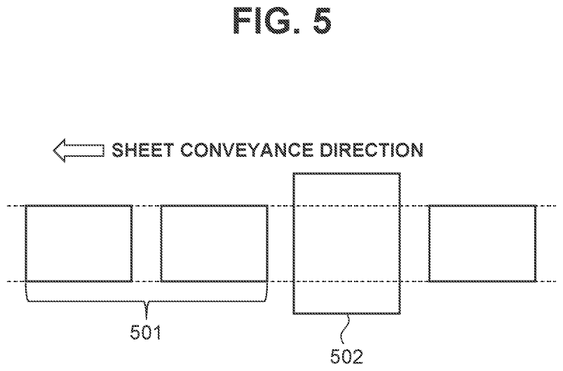

FIG. 5 illustrates a state where a recording material 502 with a larger width is inserted as a divider sheet while printing is continuously performed on recording materials 501. The divider sheet according to the present exemplary embodiment is a generally used divider sheet (insertion sheet) and, for example, is used for a user to check the number of recording materials after printing. As a specific example, the divider sheet is inserted between jobs, or is inserted every predetermined number of sheets. In the present exemplary embodiment, the divider sheet passes through the nip portion of the fixing device 109.

The user can make a divider sheet setting from the operation unit P. For example, in the case of making job settings, the user can make the divider sheet setting from a user interface (UI) display for an insertion sheet, a divider sheet, and the like. The present exemplary embodiment illustrates an example where an image can be formed on the divider sheet. However, the present exemplary embodiment is not limited to this example. Alternatively, a configuration for prohibiting image formation on the recording material designated as the divider sheet may be used. Since the divider sheet is inserted for the user to check the number of recording materials, the divider sheet may be used without forming any image on the divider sheet.

The divider sheet is fed from the sheet feed cassette 108. Accordingly, the recording material designated as the divider sheet also passes through the fixing device 109 along a conveyance path.

As is understood from the use application of the divider sheet as described above, a recording material having a width greater than that of other recording materials to be printed can be used as the divider sheet to function as the separation between sheets in many cases. In this case, if an image is also fixed onto the divider sheet, the above-described print quality improvement processing is executed every time an image is fixed onto each sheet, which leads to an increase in print job time.

Image formation is not performed on the divider sheet in many cases. Even if image formation is performed on the divider sheet, only a small image indicating numbers or the like may be formed on the divider sheet in many cases. Specifically, an image indicating page information, character information, or the like is formed on the divider sheet. According to the present exemplary embodiment, during a job in which the sheet type changes from a sheet with a smaller width to a sheet with a larger width and the sheet with a larger width corresponds to the divider sheet, downtime due to the temperature control processing of the heating member 110 is reduced. This makes it possible to prevent an increase in unwanted print job time.

To make a setting for divider sheet processing in which the print quality improvement processing is not executed in the present exemplary embodiment, an insertion sheet setting for the recording material is selected and input as a recording material job attribute setting from the operation unit P or an external apparatus. A recording material having a width greater than that of other recording materials in a printing job is selected as the divider sheet. One divider sheet is set for one insertion location.

In the present exemplary embodiment, the divider sheet setting is defined as described above. However, the present exemplary embodiment is not limited to the example where one divider sheet is inserted at one insertion location. For example, a divider sheet may be inserted every predetermined number of sheets or less. In the settings for the recording material on the operation unit P or the external apparatus, a divider sheet setting in which the print quality improvement processing is not executed may be separately configured to be selected.

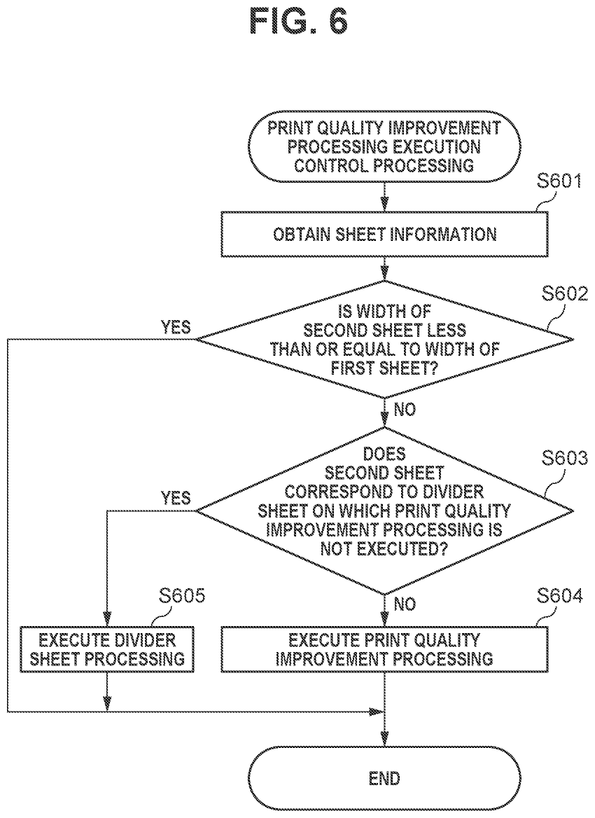

FIG. 6 is a flowchart illustrating a procedure for print quality improvement processing execution control processing to be executed by the MFP 101 illustrated in FIG. 1.

The processing illustrated in FIG. 6 is performed such that the CPU 201 executes programs stored in the HDD 203 or the ROM 204. The processing illustrated in FIG. 6 is executed during a period from when printing is performed on the first recording material to when printing on the second recording material is started, assuming that printing on the second recording material is performed after printing on the first recording material is performed. Assume herein that the first recording material is a recording material having the first width in the width direction and the second recording material is a recording material having the second width greater than the first width.

In step 601, the CPU 201 obtains recording material information from image data on other recording materials received by the image data reception unit 305 (recording material width information obtaining means, recording material job attribute setting obtaining means). The recording material size information includes information indicating the width of the second recording material and recording material job attribute settings for the second recording material. Next, in step S602, the CPU 201 determines whether the width of the second recording material included in the obtained recording material size information is equal to the width of the first recording material on which printing has been performed immediately before printing on the second recording material is to be performed.

As a result of determination in step S602, if the width of the second recording material is equal to or less than the width of the first recording material on which printing has been performed immediately before printing on the second recording material is to be performed (YES in step S602), the CPU 201 terminates this processing. On the other hand, as a result of determination in step S602, if the width of the second recording material is greater than the width of the first recording material on which printing has been performed immediately before printing on the second recording material is to be performed (NO in step S602), the processing proceeds to step S603. In step S603, the CPU 201 determines whether the second recording material corresponds to the divider sheet on which the print quality improvement processing is not to be executed.

As a result of determination in step S603, if the second recording material does not correspond to the divider sheet on which the print quality improvement processing is not to be executed (NO in step S603), the processing proceeds to step S604. In step S604, the CPU 201 executes the above-described print quality improvement processing (processing execution means).

As a result of determination in step S603, if the second recording material corresponds to the divider sheet on which the print quality improvement processing is not to be executed (YES in step S603), the processing proceeds to step S605. In step S605, the CPU 201 executes the divider sheet processing in which the print quality improvement processing is not to be executed. After that, the CPU 201 terminates this processing. After completion of the processing illustrated in FIG. 6, the CPU 201 starts printing on another recording material. A timing when a recording material reaches the nip portion in a case where the print quality improvement processing is to be executed is different from a timing when the recording material reaches the nip portion in a case where the print quality improvement processing is not to be executed. If the print quality improvement processing is to be executed, the sheet feeding/conveyance control unit 308 changes the timing of conveying the recording material.

Thus, a period of time (second period of time) from when the first recording material reaches the nip portion to when the second recording material reaches the nip portion is longer than the first period of time. On the other hand, if the print quality improvement processing is not to be executed, the period of time (second period of time) from when the first recording material reaches the nip portion to when the second recording material reaches the nip portion is equal to the first period of time. As a result, the second recording material reaches the nip portion in a period of time less than the second period of time.

In the case of executing the print quality improvement processing, the fixing control unit 309 performs control to reduce the difference between the temperature of the sheet-passing area of the first recording material 401 and the temperature of each of the sheet-passing area of the second recording material 402 and the non-sheet-passing area of the first recording material 401. If images are continuously fixed onto the first recording materials 401, the difference between the temperature of the sheet-passing area of the first recording material 401 and the temperature of each of the sheet-passing area of the second recording material 402 and the non-sheet-passing area of the first recording material 401 is large. Thus, in the state where the temperature difference is large, the print quality improvement processing is executed to thereby reduce the temperature difference. When the temperature difference is a predetermined temperature difference (first temperature difference) or less, the second recording material 402 is allowed to pass. If the print quality improvement processing is not to be executed, the second recording material 402 is allowed to pass even when the difference between the temperature of the sheet-passing area of the first recording material 401 and the temperature of each of the sheet-passing area of the second recording material 402 and the non-sheet-passing area of the first recording material is large (second temperature difference).

In the present exemplary embodiment, the central thermistor 112 detects the temperature of the sheet-passing area of the first recording material 401, and the end thermistors 113 detect the temperature of the sheet-passing area of the second recording material 402 and the temperature of the non-sheet-passing area of the first recording material 401.

The above-described operation makes it possible to reduce unwanted downtime by selecting to execute the divider sheet processing even when the width of the recording material designated as the divider sheet is greater than the width of each of the preceding recording material and the following recording material.

The print quality improvement processing in step S604 is executed when a recording material with a larger size in the width direction is detected so that temperature non-uniformity on the fixing roller 110 can be reduced. However, if temperature non-uniformity on the fixing roller 110 is small, there is no need to execute the print quality improvement processing. Accordingly, in this case, the print quality improvement processing may be skipped. Specifically, if the determination result in step S603 indicates “NO”, and if the difference between the temperature detected by the central thermistor 112 and the temperature detected by each end thermistor 113 is more than or equal to the predetermined temperature, the processing proceeds to S604. If the difference is less than the predetermined temperature, the print quality improvement processing is not to be executed, and then the processing in the flowchart ends.

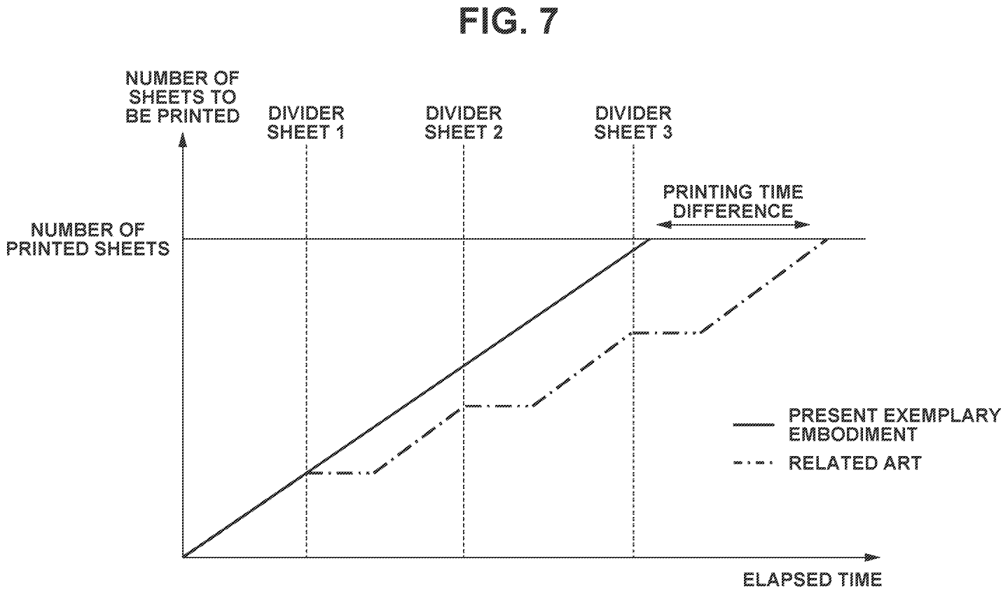

FIG. 7 is a graph illustrating a comparison between an elapsed time before a printing operation ends in the related art and the elapsed time in the present exemplary embodiment. As an example of the operation, a job in which three divider sheets 1, 2, and 3, which are recording materials of the same type, are inserted during a print job is executed. The divider sheets 1, 2, and 3 are recording materials that are of the same type as that of the recording materials in another print job, and the width of each of the divider sheets 1, 2, and 3 is greater than the width of each recording material in the other print job.

In the related art, in a case where printing is to be performed on each divider sheet, a recording material conveyance operation is suspended for about 30 seconds to 60 seconds as the print quality improvement processing. Because the three divider sheets 1, 2, and 3 are inserted in this print job, the print quality improvement processing operation requires a cumulative time of about 90 seconds to 180 seconds. On the other hand, in the present exemplary embodiment, the print quality improvement processing operation is not to be carried out even when printing is performed on each divider sheet. This eliminates the need for the suspension period described above, so that the printing operation can be finished earlier by the cumulative time of 90 seconds to 180 seconds than that of the related art. Consequently, according to the present exemplary embodiment, it is possible to prevent an increase in print job time.

An exemplary embodiment of the present disclosure has been described above. Alternatively, considering a demand for improvement in visibility of character information or the like to be printed on each divider sheet, control processing for executing an operation on condition that the operation is performed for a period of time shorter than the period of time for the normal print quality improvement processing may be executed. Specifically, the divider sheet processing in step S605 illustrated in FIG. 6 may be executed in a shorter period of time than that for the print quality improvement processing. The print job time in a case where the divider sheet setting is not made can be reduced, although the print job time may be slightly longer than that when the print quality improvement processing is not executed as described above.

Even in the case where the divider sheet setting is made, a function for executing the print quality improvement processing in the same manner as in the case where the divider sheet setting is not made may be provided. In some cases, it may be desirable to maintain the high quality of a toner image formed on a divider sheet. In this case, the print quality improvement processing is executed regardless of whether the divider sheet setting is made. ON/OFF of the divider sheet setting can be input from the operation unit P or an external apparatus. Alternatively, an apparatus may recognize the presence or absence of a toner image on a divider sheet and may automatically make the setting.

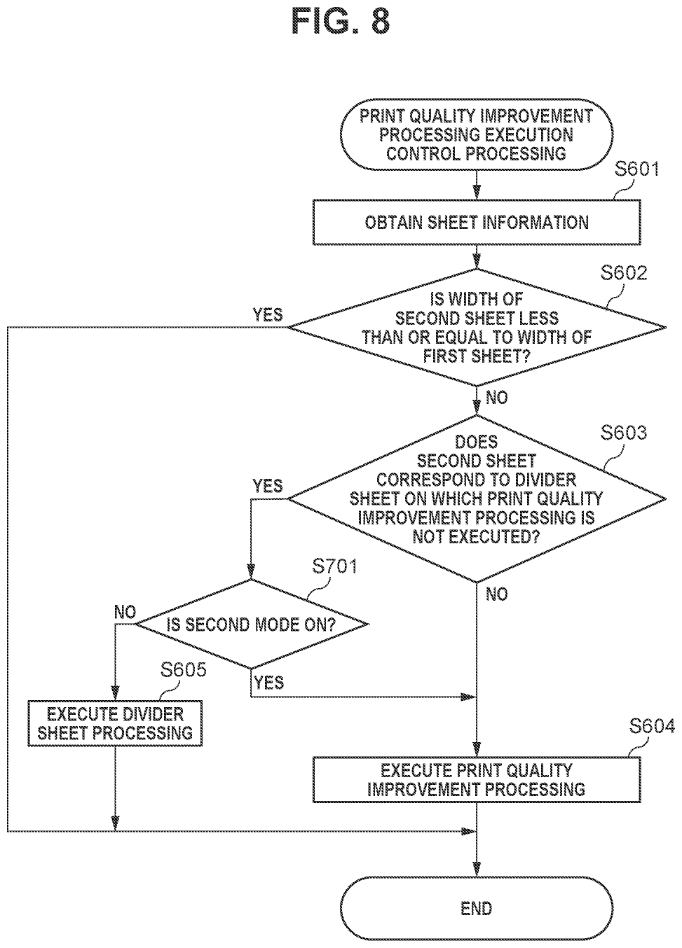

A second exemplary embodiment will be described. FIG. 8 is a flowchart illustrating a procedure for a modified example of the print quality improvement processing execution control processing illustrated in FIG. 6.

The processing illustrated in FIG. 8 is performed such that the CPU 201 executes programs stored in the HDD 203 or the ROM 204. The processing illustrated in FIG. 8 is executed during a period from when printing is performed on the first recording material to when printing on the second recording material is started, assuming that printing is performed on the second recording material after printing on the first recording material is performed.

In the processing illustrated in FIG. 8, the CPU 201 executes the processing of step S601, the processing of step S602, and the processing of step S603 illustrated in FIG. 6. As a result of determination in step S603, if the second recording material corresponds to the divider sheet on which the print quality improvement processing is not to be executed (YES in step S603), the processing proceeds to step S701. In step S701, the CPU 201 refers to a mode setting.

In the present exemplary embodiment, the divider sheet can be conveyed in one of a plurality of modes including a first mode and a second mode. Assume that the mode setting can be made from the operation unit P or the like.

As a result of determination in step S701, if the second mode is ON (YES in step S701), the processing proceeds to step S604. In step S604, the CPU 201 executes the print quality improvement processing (processing execution means).

As a result of determination in step S701, if the first mode is ON (NO in step S701), the processing proceeds to step S605. In step S605, the CPU 201 executes the divider sheet processing in which the print quality improvement processing is not to be executed. After that, the CPU 201 terminates this processing. After completion of the processing illustrated in FIG. 8, the CPU 201 starts printing on another recording material.

The above-described operation makes it possible to meet the needs for preventing deterioration in the quality of an image formed on a recording material with a larger width set as a divider sheet.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described Embodiments and/or that includes one or more circuits (e.g., application specific integrated circuit (ASIC)) for performing the functions of one or more of the above-described Embodiments, and by a method performed by the computer of the system or apparatus by, for example, reading out and executing the computer executable instructions from the storage medium to perform the functions of one or more of the above-described Embodiments and/or controlling the one or more circuits to perform the functions of one or more of the above-described Embodiments. The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-005541, filed Jan. 18, 2023, and No. 2023-190436, filed Nov. 7, 2023, which are hereby incorporated by reference herein in their entirety.

What is claimed is:

1. An image forming apparatus comprising:
an image forming unit configured to form a toner image on a recording material;
a heating rotary member configured to apply heat to the recording material carrying the toner image; and
a pressure rotary member configured to contact with the heating rotary member to form a nip portion,
wherein the pressure rotary member and the heating rotary member are configured to apply heat and pressure to the recording material carrying the toner image to fix the toner image onto the recording material,
wherein the image forming apparatus is configured to perform printing on a recording material with a first width and a recording material with a second width, wherein the first width is a length of the recording material in a width direction perpendicular to a conveyance direction of the recording material, and the second width is greater than the first width, and
wherein a period of time from when a first recording material with the first width reaches the nip portion to when a second recording material with the second width, that follows the first recording material with the first width and has no image to be formed thereon by the image forming unit, reaches the nip portion is shorter than a period of time from when the first recording material with the first width reaches the nip portion to when a third recording material with the second width that follows the first recording material with the first width and has an image to be formed thereon by the image forming unit reaches the nip portion.

2. The image forming apparatus according to claim 1, wherein the recording material with the second width is a divider sheet.

3. The image forming apparatus according to claim 2, further comprising an operation unit configured to enable a user to operate a sheet type in a job,
wherein the divider sheet is settable from the operation unit.

4. The image forming apparatus according to claim 3, wherein the image forming unit is configured not to form an image on a recording material set as the divider sheet.

5. The image forming apparatus according to claim 2, further comprising a sheet feed cassette onto which the recording material is fed,
wherein the divider sheet is conveyed from the sheet feed cassette.

6. The image forming apparatus according to claim 2, further comprising:
a first detection member configured to detect a temperature of a first area; and
a second detection member configured to detect a temperature of a second area,
wherein the first area is a central portion of the heating rotary member in an area through which a recording material is to pass in the width direction, and
wherein the second area is an area outside of an area of the heating rotary member through which a recording material with a minimum width is to pass in the area through which the recording material passes in the width direction.

7. The image forming apparatus according to claim 6, wherein the second detection member is configured to detect a temperature of an area through which the recording material with the second width passes on an outside of an area through which the first recording material with the first width passes in the width direction.

8. The image forming apparatus according to claim 7, wherein, in a case where a difference between the temperature of the first area and the temperature of the second area is less than or equal to a predetermined temperature, a period of time from when the first recording material with the first width reaches the nip portion to when the second recording material with the second width that follows the recording material with the first width and has no image to be formed thereon by the image forming unit reaches the nip portion is equal to a period of time from when the first recording material with the first width reaches the nip portion to when the third recording material with the second width that follows the recording material with the first width and has an image to be formed thereon by the image forming unit reaches the nip portion.

9. The image forming apparatus according to claim 6, wherein a difference between the temperature of the first area and the temperature of the second area in a case where the first recording material with the first width reaches the nip portion and the third recording material with the second width that follows the recording material with the first width and has an image to be formed thereon by the image forming unit reaches the nip portion is smaller than the difference between the temperature of the first area and the temperature of the second area in a case where the first recording material with the first width reaches the nip portion and the second recording material with the second width that follows the recording material with the first width and has no image to be formed thereon by the image forming unit reaches the nip portion.

10. An image forming apparatus comprising:
an image forming unit configured to form a toner image on a recording material;
a heating rotary member configured to apply heat to the recording material carrying the toner image; and
a pressure rotary member configured to contact with the heating rotary member to form a nip portion,
wherein the pressure rotary member and the heating rotary member are configured to apply heat and pressure to the recording material carrying the toner image to fix the toner image onto the recording material,
wherein the image forming apparatus is configured to perform printing on a recording material with a first width and a recording material with a second width, wherein the first width is a length of the recording material in a width direction perpendicular to a conveyance direction of the recording material, and the second width is greater than the first width, and
wherein a period of time from when a first recording material with the first width reaches the nip portion to when a second recording material with the second width, that follows the first recording material with the first width and is a divider sheet, reaches the nip portion is shorter than a period of time from when the first recording material with the first width reaches the nip portion to when a third recording material with the second width that follows the first recording material with the first width and is not a divider sheet reaches the nip portion.

11. The image forming apparatus according to claim 10, further comprising an operation unit configured to enable a user to operate a sheet type in a job,
wherein the divider sheet is settable from the operation unit.

12. The image forming apparatus according to claim 10, further comprising a sheet feed cassette onto which the recording material is fed,
wherein the divider sheet is conveyed from the sheet feed cassette.

13. The image forming apparatus according to claim 10, further comprising:
a first detection member configured to detect a temperature of a first area; and
a second detection member configured to detect a temperature of a second area,
wherein the first area is a central portion of the heating rotary member in an area through which a recording material is to pass in the width direction, and
wherein the second area is an area outside of an area of the heating rotary member through which a recording material with a minimum width is to pass in the area through which the recording material passes in the width direction.

14. The image forming apparatus according to claim 13, wherein the second detection member is configured to detect a temperature of an area through which the recording material with the second width passes on an outside of an area through which the first recording material with the first width passes in the width direction.

15. The image forming apparatus according to claim 14, wherein, in a case where a difference between the temperature of the first area and the temperature of the second area is less than or equal to a predetermined temperature, a period of time from when the first recording material with the first width reaches the nip portion to when the second recording material with the second width that follows the recording material with the first width and is a divider sheet reaches the nip portion is equal to a period of time from when the first recording material with the first width reaches the nip portion to when the third recording material with the second width that follows the recording material with the first width and is not a divider sheet reaches the nip portion.

16. The image forming apparatus according to claim 13, wherein a difference between the temperature of the first area and the temperature of the second area in a case where the first recording material with the first width reaches the nip portion and the third recording material with the second width that follows the recording material with the first width and is not a divider sheet reaches the nip portion is smaller than the difference between the temperature of the first area and the temperature of the second area in a case where the first recording material with the first width reaches the nip portion and the second recording material with the second width that follows the recording material with the first width and is a divider sheet reaches the nip portion.
